(19) United States
(12) Patent Application Publication
(10) Pub. No.: US 2024/0302537 A1
(43) Pub. Date: Sep. 12, 2024

(54) Method for Detecting at least one Hardware Error in at least one GNSS Signal Transmission Path of a Locating System

(71) Applicant: Robert Bosch GmbH, Stuttgart (DE)

(72) Inventors: Henry Conrad, Markgroeningen (DE); Safwat Irteza Butt, Hildesheim (DE)

(21) Appl. No.: 18/571,067

(22) PCT Filed: May 30, 2022
(86) PCT No.: PCT/EP2022/064580

§ 371 Date: Dec. 15, 2023

(30) Foreign Application Priority Data
Jun. 17, 2021 (DE) 10 2021 206 217.2

(51) Int. Cl. G01S 19/23; G01S 19/37

(52) U.S. Cl. CPC G01S 19/23; G01S 19/37

(57) ABSTRACT

A method is for detecting at least one hardware error in at least one global navigation satellite system (“GNSS”) signal transmission path of a locating system. The locating system includes at least one GNSS antenna and at least one GNSS receiver. The at least one GNSS receiver includes a programmable amplifier. An analog-to-digital converter is arranged between the programmable amplifier and a control unit. The method includes receiving a signal using the at least one GNSS antenna, and regulating the received signal using the programmable amplifier associated with the at least one GNSS receiver, such that the received signal is regulated according to a predefinable first reference value. The method also includes outputting a predetermined second reference value when no signal is present, and detecting at least one hardware error in at least one GNSS signal transmission path of the locating system when the second reference value is output.

### PRIOR ART

The present invention relates to a method for detecting at least one hardware error in at least one GNSS signal transmission path of a locating system.

A locating system determines the positioning of an object based on radio signals transmitted by the satellites of the Global Navigation Satellite Systems (GNSS). A GNSS signal is received by a GNSS antenna and input to a control unit via a GNSS signal transmission path. The so-called GNSS signal transmission path normally comprises a number of electronic components, e.g., connectors, diplexers, SAW filters, power distributors, amplifiers, etc., which are electrically connected in series with each other and/or parallel to each other with a data-routing capacity.

If there is a hardware error in the GNSS signal transmission path, the performance and functionality of the locating system is weakened. This is particularly important for autonomous driving for positioning within a safety-relevant deviation tolerance.

For example, a hardware error could result in a permanent or random short circuit or open circuit between components in the GNSS signal transmission path caused by faulty soldering. A hardware error could also be caused, for example, by short circuits due to conductive particles in a printed circuit board in which the GNSS signal transmission path is at least partially located. In addition, a faulty power supply to the GNSS antenna may also result in a hardware error.

Therefore, for functional safety and quality reasons, in particular in the field of autonomous driving, a real-time and permanent detection of hardware errors in the GNSS signal transmission route is considered necessary.

However, with the previously known methods, such hardware errors, in particular during the operation of the locating system, are very complex to detect. For example, a hardware error may be determined by a test body, which, however, could potentially lead to a quality degradation of the GNSS signal.

It is therefore to be considered how the hardware errors described above can be detected in real-time and permanently without the aid of a test body, but with the aid of electronic components, in particular the electronic components that are already present in the GNSS signal transmission path, during operation of the locating system.

### DISCLOSURE OF THE INVENTION

Based on this, a particularly advantageous method for detecting at least one hardware error in at least one GNSS signal transmission path of a locating system is described here. Advantageous further developments are specified in the dependent claims. The description, in particular in connection with the figures, explains the invention and specifies further advantageous design variants. The features individually mentioned in the claims can be combined with each other as desired and/or specified/interchanged with features of the description.

Described here is a method for detecting at least one hardware error in at least one GNSS signal transmission path of a locating system, wherein the locating system comprises at least one GNSS antenna and at least one GNSS receiver, wherein the GNSS antenna and the at least one GNSS receiver are connected to each other in a data-routing capacity to form a GNSS signal transmission path, the GNSS receiver having an associated programmable amplifier, and an analogue-to-digital converter being arranged between the programmable amplifier and a control unit in a data-routing capacity, comprising at least the following steps:
a) receiving a signal by means of the GNSS antenna;
b) regulating the received signal by way of the programmable amplifier associated with the at least one GNSS receiver in such a way that the signal is regulated according to a predefinable first reference value, comprising the following sub-steps:
i) amplifying the signal to the first reference value if the signal is less than the first reference value,
ii) attenuating the signal down to the first reference value if the signal is greater than the first reference value,
iii) outputting a predetermined second reference value if no signal is present;
c) detecting at least one hardware error in at least one GNSS signal transmission path of the locating system when the second reference value is output.

Amplification or attenuation of the signal here describes in particular an amplifying or attenuating adjustment of a level (signal level) of the signal. Preferably, adjusting the level may be understood as an even adjustment of the amplitudes of all frequency components of the signal.

The method described is particularly advantageously applied as redundancy in an autonomous motor vehicle, which is positioned by means of a locating system.

The signal received by the GNSS antenna may be a GNSS signal and/or a noise, or a GNSS signal included in noise. In particular, the GNSS signal here means the signal transmitted from a Global Navigation Satellite System (GNSS) and having a radio frequency (RF) over 1 GHz. In the following, the invention is described by means of an exemplary GNSS signal. It would also be conceivable, however, that a thermal noise that can be detected by means of the GNSS antenna could already be used to implement the invention.

In particular, the GNSS signal transmission path means the GNSS signal transmission path at a physical hardware level. Signal transmission from a navigation satellite system to the GNSS antenna is not considered herein.

The simplest GNSS signal transmission path includes at least one GNSS antenna and a GNSS receiver. Thus, a GNSS signal from a navigation satellite system is received by the GNSS antenna and regulated or converted by the GNSS receiver into a signal suitable for the control unit.

Depending on the complexity of the locating system, it is common to provide additional electronic components for signal processing between the GNSS antenna and the GNSS receiver.

For example, the commonly used electronic components are Low Noise Amplifiers (LNA) for amplifying the signal, switches for switching different GNSS signal transmission paths, diplexers for frequency-selective splitting of a signal for filter adjustments, etc.

A GNSS receiver includes at least one programmable gain amplifier (PGA) and an analogue-to-digital converter. Thus, the analogue signal entering the GNSS receiver is amplified by the programmable amplifier, subsequently converted into a digital signal by the analogue-to-digital converter, and then input into the control unit. In the control unit, the processed and digitalized GNSS signal is used for evaluation and positioning.

For a sophisticated locating system, a GNSS receiver may include further electronic components for improved signal processing that are connectable upstream of the programmable amplifier. Such components are, for example, low noise amplifiers (LNA).

A GNSS signal transmission path is therefore, in a broader sense, the physical hardware path from the GNSS antenna to the signal output of the GNSS receiver, comprising all electronic components that are configured between them. In particular, a hardware error means the failure of at least one component or the occurrence of short circuits or open circuits in the GNSS signal transmission path, such that signal transmission is discontinued during operation of the locating system, or there is only a very weak signal at the input of the programmable amplifier of the at least one GNSS receiver.

To detect a hardware error, substantially the programmable amplifier associated with the GNSS receiver is used. The so-called programmable gain amplifier (hereinafter referred to as PGA) can automatically amplify a signal in its level by pre-programming such that the signal at the output of the PGA has an optimal level so that the analogue-to-digital converter connected to the PGA can be optimally operated.

The PGA in the GNSS receiver also has feedback to automatically control the amplification so that the level of the signal at the output of the PGA can converge towards a predetermined optimal value if the level of the signal at the input of the PGA is within a predetermined tolerance range.

With the aid of the PGA, a hardware error in the GNSS signal transmission path can be easily and effectively detected. This is because if there is a hardware error in the GNSS signal transmission path, after a GNSS signal has been received by the GNSS antenna in step a), there is no or only a very weak signal at the input of the PGA, the level of which is well below the predetermined tolerance range. This input signal anomaly may be detected by the PGA. To this end, only a second reference value must be specified in response to such an input signal abnormality and inputted as an output signal to the control unit to signal a hardware error to the control unit.

The GNSS signal is typically amplified by 20 to 30 dB after being received in step a) and prior to input to the PGA by other electronic components due to signal processing, so the tolerance range may be specified between 20 and 30 dB, for example. Moreover, the optimal level of the signal at the output of the PGA for optimal operation of the analogue-to-digital converter is typically approximately 80 dB, which may be applied as the first reference value for the described method.

If there is no hardware error, the PGA is in normal operation and performs sub-step i) or sub-step ii), namely if the level of the signal at the input of the PGA is less than 80 dB, the level in sub-step i) is amplified up to 80 dB, and if the level of the signal at the input of the PGA is greater than 80 dB, then the level in sub-step ii) is attenuated down to 80 dB.

In the presence of a hardware error, the PGA detects that there is no or only a very weak signal at its input whose level is well below the tolerance range. Thus, in response to this input signal anomaly, the PGA will provide a second reference value in sub-step iii). The second reference value is preferably greater than the first reference value.

The signal emitted by the PGA is used via the analogue-to-digital converter in the control unit for positioning an object; thus, the control unit detects a hardware error in step c) based on the signal emitted from the PGA as soon as the PGA outputs a second reference value.

The method described uses the already existing PGA for detecting hardware errors in the GNSS signal transmission path from the GNSS antenna to the output of the PGA during operation of the locating system. To do this, it is only necessary to specify a second reference value. Once the PGA detects that the level of the signal is well below the tolerance range, the PGA will output the second reference value, which will signal a hardware error to the control unit.

The described method does not require any additional testing equipment or complex algorithms. It is inexpensive to implement and suitable for the mass production of locating systems operated using the method described.

It is preferred when in step a) the signal is received by an active GNSS antenna.

The satellites of the GNSS satellite constellation transmit encoded radio navigation signals (i.e. GNSS signals) to be received by a receiver of the locating system below the level of thermal noise.

On the one hand, the GNSS signals are very weak; on the other hand, they are further attenuated during their transmission via the GNSS signal transmission path to the control unit due to transmission losses caused by coaxial cables and subsequent signal processing. It is therefore advantageous if, in step a), the GNSS signal is received by an active GNSS antenna comprising at least one low noise amplifier (LNA), such that the GNSS signal can be amplified once during reception, taking the thermal noise level into account. It is preferable to amplify the GNSS signal by 20 to 30 dB. It is also preferred to supply a direct current to the LNA by a phantom supply.

It is also preferred if, between step a) and step b), the GNSS signal is pre-processed by a diplexer to separate its frequency into different frequency ranges and/or by a surface acoustic wave filter to obtain the GNSS signal with a desired frequency or with a desired frequency band.

The application of a diplexer allows different GNSS signals with different frequency bands to be received by a GNSS antenna. This is because the diplexer can, for example, separate individual frequency bands for the GNSS receiver into different frequency ranges. Thus, upon receipt of signals, a plurality of different frequency ranges may be covered.

It is particularly advantageous if a surface acoustic wave filter (SAW filter) is connected downstream of the diplexer so that the undesired frequency component of the GNSS signal can be filtered out after the frequency selective separation.

It is preferred if the at least one GNSS receiver comprises a first GNSS receiver and a second GNSS receiver, which are separate from each other and are each connected to the GNSS antenna, such that in step b) the received GNSS signal is also regulated at least in part by a second programmable amplifier associated with the second GNSS receiver.

The first GNSS receiver and the second GNSS receiver differ primarily in that the two GNSS receivers are connected in parallel with each other and in series with their own SAW filter. Thereby, two GNSS signal transmission paths are formed, each consisting of a common portion and a separate portion. With the two GNSS receivers, it can be detected whether a hardware error is in the common portion or the separate portion of one of the two GNSS receivers. For this purpose, it is irrelevant whether the two GNSS receivers have the same architecture. In other words, this means that the first GNSS receiver and the second GNSS receiver can have all components and connections between them identical or at least partially different to each another.

It is worth noting that the first and the second GNSS receivers are not only configured to detect hardware errors. Indeed, locating systems for highly accurate positioning, particularly for autonomous driving, are established with two or three or even more GNSS receivers anyway. Such a locating system also typically includes a Kalman filter, which, based on at least two input variables (GNSS, INS, map data, etc.), determines weighting factors of position-relevant variables and/or position-relevant variables (predictive). For example, a GNSS signal may be read as an input variable via the first GNSS receiver and a GNSS correction signal as the other input variable via the second GNSS receiver from the Kalman filter.

It is preferred if, in step c), it is detected that there is a hardware error in a portion of the GNSS signal transmission path leading only to the first GNSS receiver if the second reference value was output exclusively from the first GNSS receiver.

It is also preferred if, in step c), it is detected that there is a hardware error in a portion of the GNSS signal transmission path leading only to the second GNSS receiver if the second reference value was output exclusively from the second GNSS receiver.

It is particularly preferred if, in step c), it is detected that there is a hardware error in a common portion of the GNSS signal transmission path if the second reference value was output from the first and the second GNSS receiver.

As described further above, a GNSS signal from the GNSS antenna enters the control unit via the programmable amplifier of a GNSS receiver. In other words, this means that the number of GNSS signal transmission paths depends on the number of GNSS receivers, in particular the number of programmable amplifiers.

For example, if a first GNSS receiver and a second GNSS receiver are connected upstream of the control unit, and if the two GNSS receivers each comprise only one programmable amplifier, a total of two GNSS signal transmission pathways are created, namely, a GNSS signal transmission path from the GNSS antenna to the programmable amplifier of the first GNSS receiver to the control unit and another GNSS signal transmission path from the GNSS antenna via the programmable amplifier of the second GNSS receiver to the control unit.

The respective GNSS signal transmission paths can consist of a common portion and a separate portion. In this case, for example, after being received from the GNSS antenna, a GNSS signal can first be separated by the diplexer into different frequency ranges, e.g., into a first frequency range and into a second frequency range, wherein the first and the second frequency range are different from each other, such that the GNSS signal portion with the first frequency range reaches the control unit via a SAW filter and subsequently via the first GNSS receiver, and/or the GNSS signal portion after the diplexer with the second frequency range also reaches the control unit via another SAW filter and the second GNSS receiver. To this end, the common portion is formed from the GNSS antenna up to the output of the diplexer. The respective separate portions are formed from the output of the diplexer, via the GNSS receiver associated with the respective portions, to the control unit.

It can thus be determined in which portion of the two GNSS signal transmission paths at least one hardware error is present, depending on which GNSS receiver outputs a second reference value. For example, a hardware error is shown:
in the common portion, when the two GNSS each output a second reference value, and
in a separate portion, when the GNSS receiver associated with this separate portion outputs a second reference value and the other GNSS receiver does not output a second reference value.

The above is only a simple example. Indeed, a high-precision navigation system typically comprises m (e.g., m=3) GNSS receivers. Each GNSS receiver also has n (e.g., n=2) signal channels. This means that there may be a total of m×n (e.g., 3×2=6) GNSS signal transmission paths.

The more GNSS signal transmission paths there are, the more accurately the described method can be used to determine which portion has a hardware error.

It is preferred if a computer program is used to carry out a method described here. In other words, this relates in particular to a computer program (product) comprising commands which, when the program is executed by a computer, prompt said computer to perform a method described here.

It is particularly preferred if a machine-readable storage medium is used, on which the computer program proposed here is stored. Conventionally, the machine-readable storage medium is a computer-readable data medium.

It is also preferred if the locating system for a vehicle is configured to perform a method described here.

The solution presented herein and the technical environment thereof are explained in greater detail hereinafter making reference to the drawings. It should be noted that the invention is not intended to be limited by the exemplary embodiments disclosed. In particular, unless explicitly stated otherwise, it is also possible to extract partial aspects of the factual subject matter described in relation to the drawings and to combine them with other components and/or knowledge based on other drawings and/or the present description. Shown schematically are:

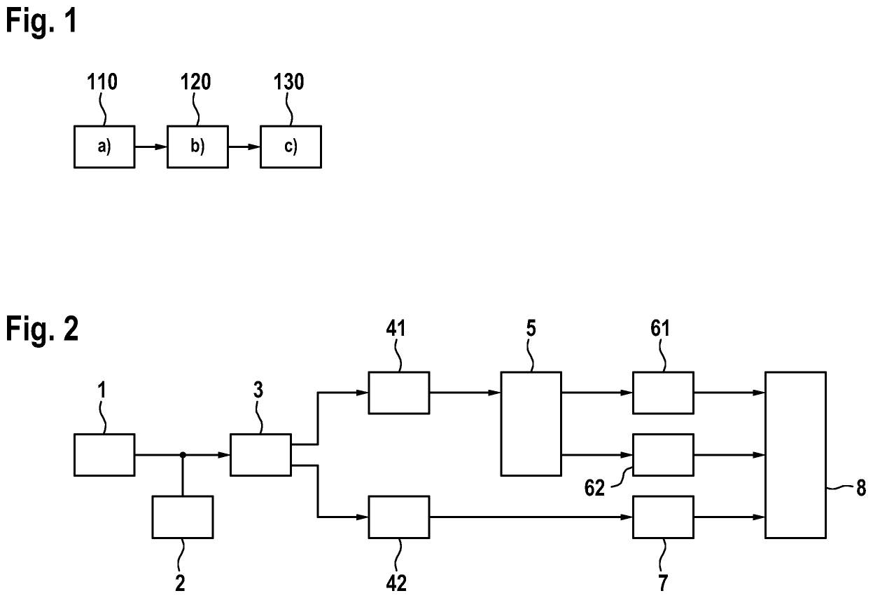

FIG. 1 shows a sequence of a method presented here for detecting at least one hardware error in at least one GNSS signal transmission path of a locating system during regular operation.

FIG. 2. shows exemplary GNSS signal transmission paths, and

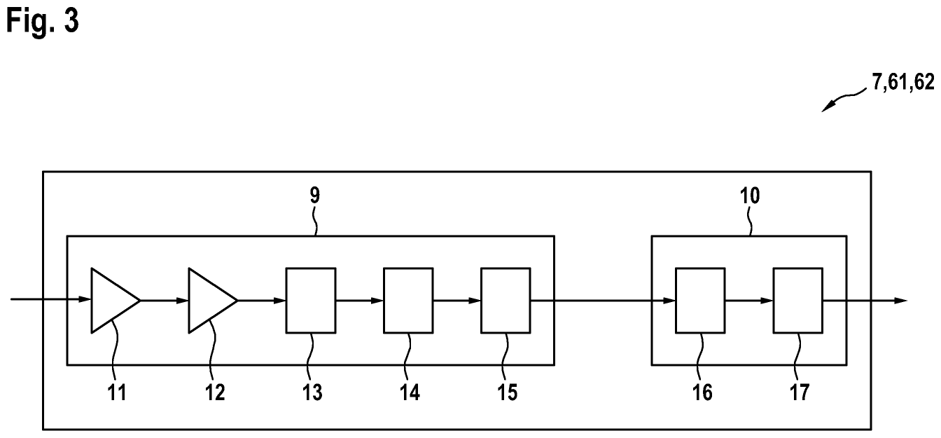

FIG. 3 shows an exemplary GNSS receiver.

FIG. 1 schematically shows a sequence of a method presented here for detecting at least one hardware error in at least one GNSS signal transmission path of a locating system during regular operation. The illustrated sequence of the method steps a), b), and c) with the blocks 110, 120, 130 is merely exemplary. A GNSS signal is received by the GNSS antenna 1 in block 110. In block 120, the received GNSS signal is regulated by the programmable amplifier associated with the at least one GNSS receiver 61,62,7 according to a predefinable first reference value, such that if the level of the GNSS signal is less than the first reference value, the level of the GNSS signal is amplified up to the first reference value; and if the level of the GNSS signal is greater than the first reference value, the level of the GNSS signal is attenuated down to the first reference value; and if there is no GNSS signal, a predetermined second reference value is delivered. In block 130, at least one hardware error is detected in at least one GNSS signal transmission path of the locating system when the second reference value is output.

In particular, the method step b) of a plurality of GNSS receivers 61,62,7 can proceed at least in part in parallel or at the same time.

FIG. 2 and FIG. 3 schematically show and exemplify GNNS signal transmission paths with respect to electronic components and their connections. In the following, the method described with respect to FIG. 2 and FIG. 3 and with reference to the electronic components is explained in more detail.

FIG. 2 schematically shows three GNSS signal transmission paths, namely:
A first GNSS signal transmission path formed by the GNSS antenna 1, the diplexer 3, the SAW filter 41, the power splitter 5, the first GNSS receiver 61 and the control unit 8,
A second GNSS signal transmission path formed by the GNSS antenna 1, the diplexer 3, the SAW filter 41, the power splitter 5, the first GNSS receiver 62, and the control unit 8, and
A third GNSS signal transmission path formed by the GNSS antenna 1, the diplexer 3, the SAW filter 42, the second GNSS receiver 7 and the control unit 8.

A GNSS signal may be transmitted from the GNSS antenna 1 to the control unit 8 via one of the three GNSS signal transmission paths or at the same time via all three GNSS signal transmission paths.

In this case, for example, after being received from the GNSS antenna 1, a GNSS signal can first be separated by the diplexer 3 into different frequency ranges, e.g., in a first frequency range and in a second frequency range, wherein the first and second frequency ranges are different from each other, such that the GNSS signal portion with the first frequency range reaches the control unit 8 via the SAW filter 41 and subsequently via the first GNSS receiver 61, and/or can reach the control unit 8 after the SAW filter 41 via an additional power splitter 5 and subsequently via the first GNSS receiver 62, and/or the GNSS signal portion after the diplexer 3 with the second frequency range reaches the control unit 8 via the SAW filter 42 and the second GNSS receiver 7. In this case, a GNSS signal may be transmitted to control unit 8 at the same time at most via three GNSS signal transmission paths. This is particularly advantageous for the subsequent highly accurate positioning with the aid of a Kalman filter in the control unit 8. The phantom power supply 2 is used for the power supply for the GNSS antenna 1.

FIG. 3 provides a schematic and exemplary illustration of a known GNSS receiver 61, 62, 7 comprising at least one signal channel consisting of the portion A 9 for signal processing and portion B 10 for converting the analogue signal coming from portion A 9 into the digital signal. In this case, portion A 9 may comprise, for example, a low noise amplifier (LAN) 11 and/or a radio frequency amplifier (RFA) 12 and/or a mixer 13 and/or a calibration module 14 and/or a reconfigurable filter 15 depending on the architecture. Here, portion B 10 may comprise a programmable amplifier (PGA) 16 and an analogue-to-digital converter (ADC) 17.

In portion B 10, the programmable amplifier 16 amplifies the signal processed in portion A 9 such that the analogue-to-digital converter 17 operates at optimum if there is no hardware error. In this case, the total amplification in the GNSS receiver 61, 62, 7 is approximately 80 dB. Whereas, if a very weak signal at a level of up to zero is present at the input of the programmable amplifier 16, the programmable amplifier 16 amplifies up to the maximum value that can be pre-programmed as the second reference value. In this case, the amplified value is forwarded to control unit 8 (not shown in FIG. 3). The control unit 8 evaluates this value and makes the decision as to whether a hardware error is present.

It can further be determined in which portion of the various GNSS signal transmission paths at least one hardware error is present, depending on which GNSS receiver 61, 62, 7 outputs the second reference value. For example, a hardware error is shown:
in the first GNSS receiver 61 if the first GNSS receiver 61 outputs a second reference value and the first GNSS receiver 62 and the second GNSS receiver 7 do not output a second reference value,
in the first GNSS receiver 62 if the first GNSS receiver 62 outputs a second reference value and the first GNSS receiver 61 and the second GNSS receiver 7 do not output a second reference value,
between the output of the diplexer 3 and the input of the programmable amplifier 16 of the second GNSS receiver 7 if the second GNSS receiver 7 outputs a second reference value and the two first GNSS receivers 61, 62 do not output a second reference value, and
between the GNSS antenna 1 and the diplexer 3 if all GNSS receivers 7, 61, 62 each output a second reference value.

As described above, the solution presented herein makes it possible to detect at least one hardware error in at least one GNSS signal transmission path in real time and permanently during operation of the locating system based on the components already installed in a locating system, in particular without adding or supplementing additional components. For this purpose, it is sufficient to merely specify a second reference value and program the programmable amplifier of the respective GNSS receivers to output the second reference value in response to an input signal anomaly. In addition, it is no longer necessary to indirectly detect hardware errors with the aid of a Kalman filter, thereby saving the associated calculation effort. Using the described method, hardware errors can be detected simply, effectively, and at low cost.

1. A method for detecting at least one hardware error in at least one global navigation satellite system (“GNSS”) signal transmission path of a locating system, wherein the locating system comprises at least one GNSS antenna and at least one GNSS receiver, wherein the at least one GNSS antenna and the at least one GNSS receiver are connected to each other in a data-routing capacity to form a GNSS signal transmission path, the at least one GNSS receiver having an associated programmable amplifier, an analog-to-digital converter arranged between the programmable amplifier, and a control unit in a data-routing capacity, the method comprising:
receiving a signal by way of the at least one GNSS antenna;
regulating the received signal by way of the programmable amplifier associated with the at least one GNSS receiver, in such that the received signal is regulated according to a predefinable first reference value, the regulating comprising (i) amplifying the received signal to the first reference value when the received signal is less than the first reference value, (ii) attenuating the received signal to the first reference value when the received signal is greater than the first reference value, and (iii) outputting a predetermined second reference value when no signal is present; and
detecting the at least one hardware error in the at least one GNSS signal transmission path of the locating system when the second reference value is output.

2. The method according to claim 1, wherein the receiving the signal includes receiving the signal with an active GNSS antenna of the at least one GNSS antenna.

3. The method according to claim 1, wherein, between the receiving and the regulating, the received signal is pre-processed by a diplexer to separate a frequency of the received signal into different frequency ranges and/or by a surface acoustic wave filter to obtain the received signal with a desired frequency or a desired frequency band.

4. The method according to claim 1, wherein the at least one GNSS receiver comprises a first GNSS receiver and a second GNSS receiver, which are separate from each other and are each connected to the at least one GNSS antenna, such that the received GNSS signal is further regulated at least in part by a second programmable amplifier associated with the second GNSS receiver.

5. The method according to claim 4, wherein the detecting includes detecting the at least one hardware error in a portion of the GNSS signal transmission path leading only to the first GNSS receiver when the second reference value was output exclusively from the first GNSS receiver.

6. The method according to claim 4, wherein the detecting includes detecting the at least one hardware error in a portion of the GNSS signal transmission path leading only to the second GNSS receiver when if the second reference value was output exclusively from the second GNSS receiver.

7. The method according to claim 4, wherein the detecting includes detecting the at least one hardware error in a common portion of the GNSS signal transmission path when the second reference value was output exclusively from the first and the second GNSS receiver.

8. The method according to claim 1, wherein a computer program performs the method.

9. The method according to claim 8, wherein the computer program is stored on a non-transitory machine-readable storage medium.

10. The method according to claim 1, wherein the locating system is for a vehicle which is configured to perform the method.
